(19) United States
(12) Patent Application Publication
(10) Pub. No.: US 2026/0127022 A1
(43) Pub. Date: May 7, 2026

(54) DEVICES, SYSTEMS, METHODS, AND PROGRAMS FOR DYNAMICALLY DEPLOYING APPLICATIONS

(71) Applicant: Renesas Electronics Corporation, Tokyo (JP)

(72) Inventor: Takahiro HASHIMOTO, Tokyo (JP)

(21) Appl. No.: 19/333,984

(22) Filed: Sep. 19, 2025

(30) Foreign Application Priority Data
Nov. 6, 2024 (JP) 2024-194213

(51) Int. Cl. G06F 9/48; G06F 11/30

(52) U.S. Cl. CPC G06F 9/4843; G06F 11/3051; G06F 2209/482

(57) ABSTRACT

A system dynamically deploys an application in any of a first domain, a second domain, and a third domain to which a computing resource is allocated. The system has a judgement unit and a determination unit. The judgement unit judges a resource use rate of each domain. The determination unit determines a redeployment destination of “App C” deployed in the first domain higher in the resource use rate than a first standard. Based on information about a future fluctuation of a usage amount of the computing resource in each domain, the determination unit determines, as a redeployment destination, the third domain expected so that the usage amount does not increase.

### CROSS-REFERENCE TO RELATED APPLICATIONS

The present application claims priority from Japanese Patent Application No. 2024-194213 filed on Nov. 6, 2024, the content of which is hereby incorporated by reference to this application.

### BACKGROUND

The present disclosure relates to devices, systems, methods, and programs, for example, is effectively applicable to devices, systems, methods, and programs for dynamically deploying applications.

There is a disclosed technique listed below. [Non-Patent Document 1] “Descheduler for Kubernetes”, [online], [Search on Oct. 9, 2024], Internet (URL:https://github.com/kubernetes-sigs/descheduler)

Conventionally, a technique of dynamically deploying applications to any of a plurality of management units to that computer resources are allocated has been developed. For example, Non-Patent Document 1 discloses a technique of redeploying a pod on a node having a high resource use rate to a node having a low resource use rate.

### SUMMARY

In the technique disclosed in Non-Patent Document 1, when the resource use rate at the redeployed node increases, a pod is redeployed again. The pod includes one or more applications. The application is stopped every time the pod is redeployed. Therefore, when the redeployment occurs continuously, a stop time of the application increases.

Other problems and novel features will be apparent from the description of the present specification and the accompanying drawings.

A device according to one embodiment has a judgement unit and a determination unit. The judgement unit judges a use rate of a computing resource in each of a plurality of management units. The determination unit determines a redeployment destination of a first application in a target management unit, which is higher in the use rate than a first standard, among the plurality of management units. Further, based on first information about a future fluctuation of a usage amount of the computing resource in the plurality of management units 10, the determination unit determines a management unit, which is expected so that the usage amount does not increase, from among the plurality of management units 10 as the redeployment destination.

A system according to another embodiment has: a plurality of management units to which a computing resource is allocated; a judgement unit; a determination unit; and a transference unit. The judgement unit judges a use rate of the computing resource in each of the plurality of management units. The determination unit determines, according as a use rate in a target management unit among the plurality of management units exceeds a first threshold, a redeployment destination of a first application deployed in the target management unit. The transference unit transfers the first application to the redeployment destination from the target management unit. The determination unit determines, based on first information about a future fluctuation of a usage amount of the computing resource in the plurality of management units, a management unit, which is expected so that the usage amount does not increase, from among the plurality of management units as the deployment destination.

A method according to yet another embodiment includes judging a use rate of a computing resource in each of a plurality of management units. Further, the method includes determining, according as the use rate in a target management unit among the plurality of management units exceeds a first threshold, a redeployment destination of a first application deployed in the target management unit. Determining the redeployment destination includes determining, based on first information about a future fluctuation of a usage amount of the computing resource in the plurality of management units, a management unit, which is expected so that the usage amount does not increase, among the plurality of management units as the redeployment destination.

A program according to yet another embodiment causes a computer to execute the above method.

According to each of the above embodiments, the increase in the stop time of the application is suppressed.

### BRIEF DESCRIPTION OF THE DRAWINGS

FIG. 1 is a view showing one example of the entire configuration of a system according to an embodiment.

FIG. 2 is a view showing one example of judgement of a resource use rate.

FIG. 3 is a view showing a deployment example of applications to a plurality of management units relative to a reference form at first timing.

FIG. 4 is a view showing a deployment example of applications to a plurality of management units relative to a reference form at second timing after the first timing.

FIG. 5 is a view showing a temporal change of a CPU load in the plurality of management units relative to the reference form.

FIG. 6 is a view showing a configuration of a first example of a dynamical deployment process unit according to the embodiment.

FIG. 7 is a view showing one example of an application dependency table.

FIG. 8 is a view showing one example of a priority set to the application.

FIG. 9 is a view showing a temporal change of a CPU load in the plurality of management units relative to the first example.

FIG. 10 is a diagram for explaining a process example by an updating unit.

FIG. 11 is a flowchart showing one example of a flow of a process of a dynamic deployment unit relative to the first example.

FIG. 12 is a view showing a configuration of a second example of the dynamic deployment unit according to the example.

### DETAILED DESCRIPTION

Hereinafter, embodiments of the present disclosure will be detailed with reference to the drawings. Note that the same reference numerals are denoted to the same or corresponding parts, and its explanation will not be repeated.

### Overall Configuration of System

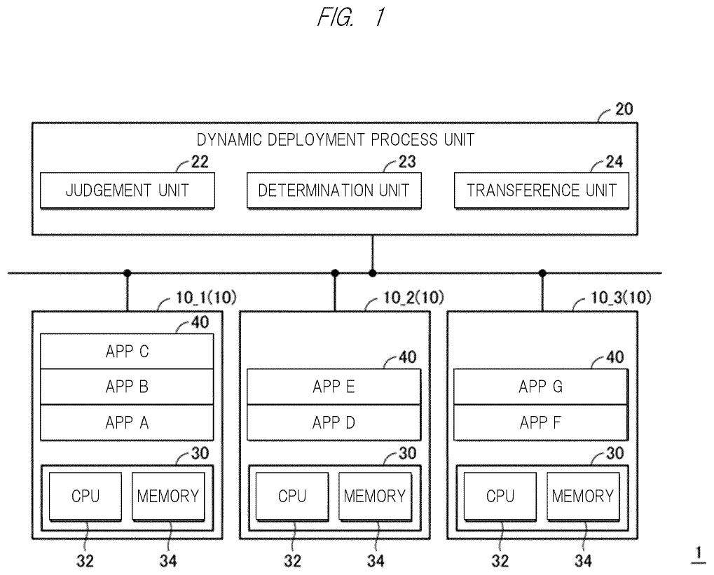

FIG. 1 is a view showing one example of the entire configuration of a system according to an embodiment. As shown in FIG. 1, a system 1 has a plurality of management units 10 and a dynamic deployment process unit 20.

Each of the plurality of management units 10 is a unit for managing a computing resource 30. That is, to each of the plurality of management units 10, the dedicated computing resource 30 is allocated. In an example shown by FIG. 1, the plurality of management units 10 includes three management units 10_1, 10_2, 10_3. However, the number of plural management units 10 is not limited particularly.

Each of the plurality of management units 10 may be, for example, a device, or may be any of a plurality of domains provided to the device. The device is, for example, a semiconductor integrated circuit such a System-on-a-chip (SoC) or a Micro Control Unit (MCU). The plurality of computing resources 30 respectively allocated to the plurality of domains provided to the device may operate according to Operating Systems (OSs) different from each other.

The computing resource 30 typically includes a Central Processing Unit (CPU) 32 and a memory 34. The memory 34 is, for example, a Random Access Memory (RAM). Note that the computing resource 30 may include a processor such as a Micro Processing Unit (MPU) instead of the CPU 32.

In each of the plurality of management units 10, one or more applications 40 is deployed. The application 40 deployed in a certain management unit is executed by the computing resource 30 allocated to the certain management unit.

The dynamic deployment process unit 20 dynamically deploys the application 40 at any of the plurality of management units 10 to which the computing resources are allocated.

The dynamic deployment process unit 20 is realized by the processor executing the program. The processor for realizing the dynamic deployment process unit 20 may be included in the computing resource 30 allocated to any of the plurality of management units 10. At this case, the program for realizing the dynamic deployment process unit 20 is an application deployed in a management function to which the computing resource 30 including the processor for realizing the dynamic deployment process unit 20 is allocated. For example, the program for realizing the dynamic deployment process unit 20 can be an “App A”deployed in the management unit 10_1.

Or, the processor for realizing the dynamic deployment process unit 20 may be included in a computing resource different from the computing resources 30 allocated to the plurality of management units 10. At this case, the program for realizing the dynamic deployment process unit 20 is deployed outside the plurality of management units 10.

The dynamic deployment process unit 20 includes a judgement unit 22, a determination unit 23, and a transference unit 24. The judgement unit 22 judges a use rate of the computing resource 30 in each of the plurality of management units 10 (hereinafter, called “resource use rate”).

The determination unit 23 determines, according to the judgement that the resource use rate at a target management unit among the plurality of management units 10 exceeds a first standard, a redeployment destination of a first application deployed in the target management unit. The first application is selected from among one or more applications deployed in the target management unit. The deployment destination is determined from among the plurality of management units 10.

The transference unit 24 transfers the first application to the redeployment destination from the target management unit. Specifically, the transference unit 24 transfers a program file indicating the first application, and data used for executing the first application.

### Judgement Example of Resource Use Rate

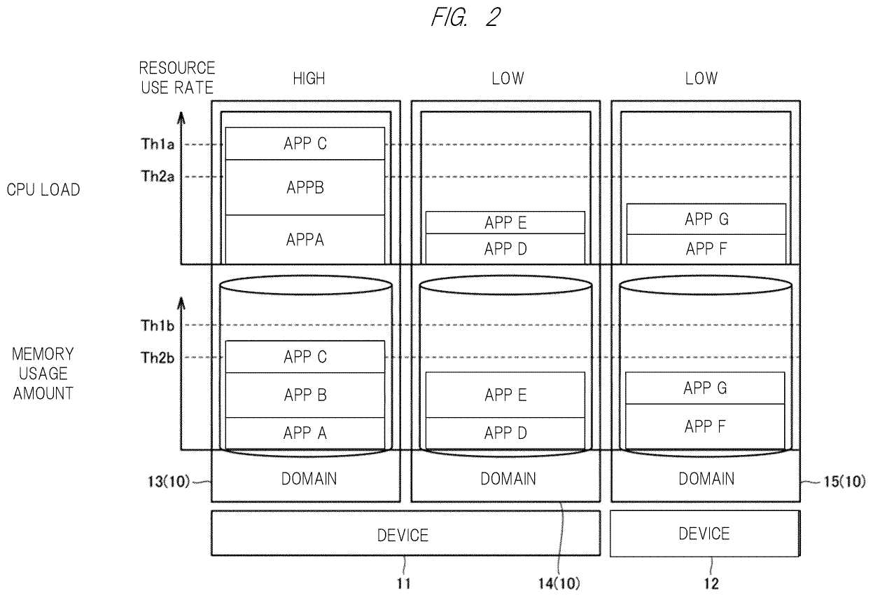

FIG. 2 is a view showing one example of judgement of a resource use rate. In an example shown by FIG. 2, the plurality of management units 10 include domains 13, 14 provided to the device 11, and a domain 15 provided to the device 12. The devices 11, 12 are communicable with each other via, for example, Ethernet (registered mark). Note that when the device 12 does not include a domain(s) other than the domain 15, the device 12 can be the management unit 10. In other words, the plurality of management units 10 include the domains 13, 14 provided to the domain 11, and the device 12.

Note that the dynamic deployment process unit 20 shown by FIG. 1 may be incorporated in the domain configuring any of the plurality of management units 10. For example, the dynamic deployment process unit 20 may be incorporated in the device 11. At this case, the device 12 is one example of “another device” of the present disclosure.

The judgement unit 22 judges whether the resource use rate is “high”, “medium”, or “low”. That the resource use rate is “high” is the same meaning as a meaning of the resource use rate being higher than a first standard. That the resource use rate is “low” is the same meaning of a meaning of the resource use rate being lower than a second standard. The second standard indicates that it is lower in a degree of use of the computing resource 30 than the first standard. That the resource use rate is “medium” is the same meaning as a meaning of the resource use rate being between the first standard and the second standard.

The judgement unit 22 judges the resource use rate based on a CPU load and a memory usage amount. Specifically, the judgement unit 22 judges that the resource use rate is “high” according as Condition (a) described later is satisfied.
Condition (a): the CPU load exceeds a threshold Th1a or the memory usage amount exceeds a threshold Th1b.
Condition (a) defines the first standard. In Condition (a), the thresholds Th1a, Th1b are preset. In an example shown by FIG. 2, since the CPU load in the domain 13 exceeds the threshold Th1a, the judgement unit 22 judges that the resource use rate in the domain 13 is “high”.

The judgement unit 22 judges that the resource use rate is “low” according as Condition (b) described later is satisfied. Condition (b): the CPU load is less than a threshold Th2a and the memory usage amount is less than a threshold Th2b.
Condition (b) defines the second standard. In Condition (b), the thresholds Th2a, Th2b are preset. The threshold Th2a is smaller than the threshold Th1a. The threshold Th2b is smaller than the threshold Th1b. In the example shown by FIG. 2, in the domains 14, 15, the CPU load and the memory usage amount are respectively less than the thresholds Th2a, Th2b, so that the judgement unit 22 judges that the resource use rates in the domains 14, 15 are “low”.

The judgement unit 22 judges that the resource use rate is “medium” according as any of Condition (a) and Condition (b) is not satisfied.

### Problems of Reference Form

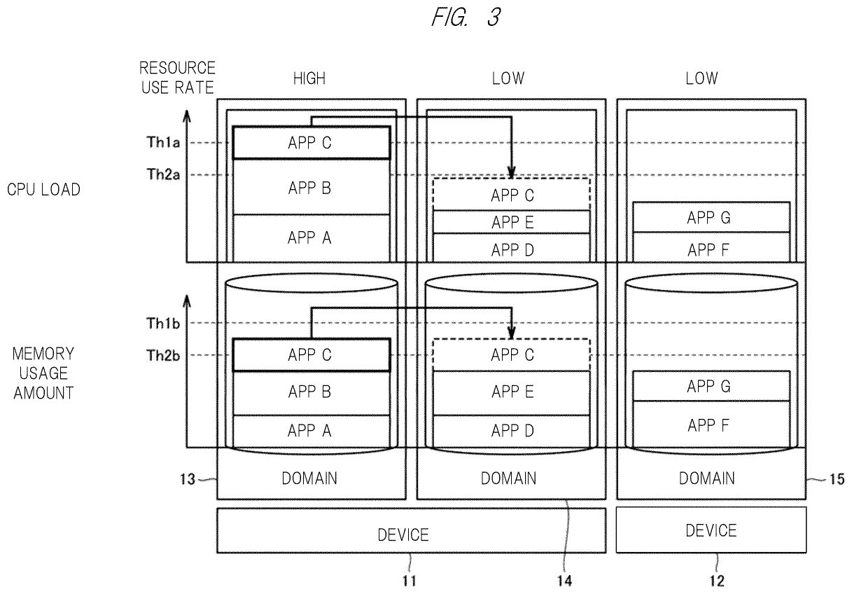

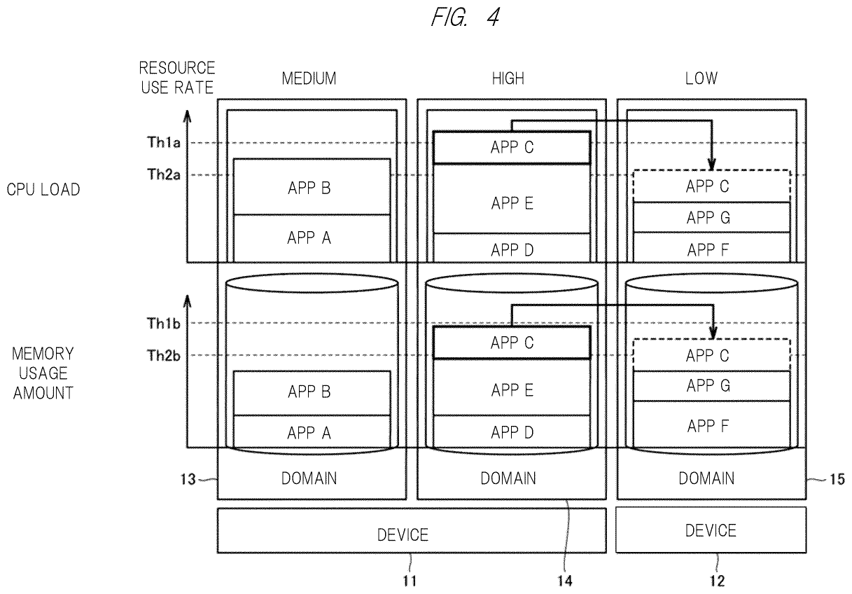

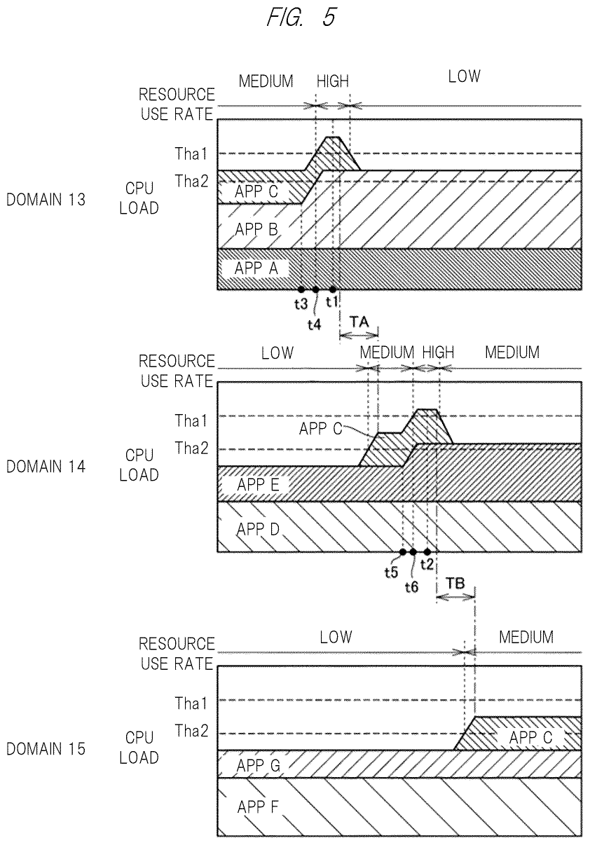

With reference to FIG. 3 to FIG. 5, problems about the reference form using the technique disclosed in Non-Patent Document 1 will be explained. FIG. 3 is a view showing a deployment example of applications to a plurality of management units relative to a reference form at first timing. FIG. 4 is a view showing a deployment example of applications to a plurality of management units relative to a reference form at second timing after the first timing. FIG. 5 is a view showing a temporal change of a CPU load in the plurality of management units relative to the reference form. In FIG. 5, a temporal change of the CPU load in a period including first timing t1 and second timing t2 is shown.

As shown in FIG. 5, from timing t3 before the first timing t1, a CPU load of “App B” deployed in the domain 13 rises. As a result, in timing t4 between the timing t3 and the first timing t1, the resource use rate in the domain 13 is judged as “high”. Therefore, one of one or more applications 40 deployed in the domain 13 is selected as a target of the redeployment. In the examples shown by FIG. 3 and FIG. 5, “App C” is selected as a target of the redeployment.

In the technique disclosed in Non-Patent Document 1, any of the domains 14, 15 in which the resource use rates are “low” is selected as the redeployment destination. In the example shown by FIG. 3, the domain 14 is selected as the redeployment destination. As a result, “App C” is redeployed at the domain 14. That is, a program file of “App C” and data used for executing “App C” are transferred to the domain 14 from the domain 13. A first redeployment process (also called “transference process”) of “App C” is carried out in a period TA shown by FIG. 5. Note that the redeployment process of the application includes a process of ending the application in the original management unit, a process of transferring the application to the management unit of the redeployment destination from the original management unit, and a process of activating the application in the management unit of the redeployment destination. Therefore, in the period AT, “App C” does not function substantially. In other words, in the period TA, “App C”is stopping substantially.

As shown in FIG. 5, from timing t5 immediately after the redeployment of “App C” to the domain 14 is completed, the CPU load due to “App E” deployed in the domain 14 rises. The timing t5 precedes the second timing t2. As a result, in timing t6 between the timing t5 and the second timing t2, the resource use rate in the domain 14 is judged as “high”. Therefore, one of one or more applications 40 deployed in the domain 14 is selected as a target of the redeployment. In the example shown by FIG. 4, “App C” is again selected as the target of the redeployment. As the redeployment destination, the domain 15 in which the resource use rate is “low” is selected. As a result, “App C” is redeployed in the domain 15. That is, the program file of “App C” and the data used for executing “App C” are transferred to the domain 15 from the domain 14. A second redeployment process of “App C” is carried out in a period TB shown by FIG. 5. Also in the period TB, “APP C” does not function substantially.

In this way, in the reference form, the redeployment process of the application 40 can be continuously carried out. As a result, a time during when the application 40 does not function substantially become long. That is, a stop time of the application 40 becomes long.

### Main Features of Embodiment

To solve the above problems, in a system 1 according to an embodiment, the determination unit 23 acquires first information about a future fluctuation of the usage amounts of the computing resources 30 in the plurality of management units 10 in determining the redeployment destination of the first application. Then, the determination unit 23 determines, as the redeployment destination, the management unit 10, which is expected so that the usage amount of the computing resource does not increase, among the plurality of management units 10 based on the first information. Consequently, the first application is redeployed at the management unit expected so that the usage amount of the computing resource does not increase. As a result, the first application continuously becomes operatable at the redeployment destination. In other words, frequency at which the first application is again selected as the target of the redeployment decreases. Therefore, an increase in the stop time of the first application is suppressed.

Note that when the first application is redeployed at the management unit at which the resource use rate is “medium”, the resource use rate at the above management unit may rise to “high”. Therefore, the determination unit 23 may specify, as one or more redeployment destination candidates, one or more management units in which the resource use rate is “low”. Then, the determination unit 23 preferably determines the redeployment destination from among one or more redeployment destination candidates.

### FIRST EMBODIMENT

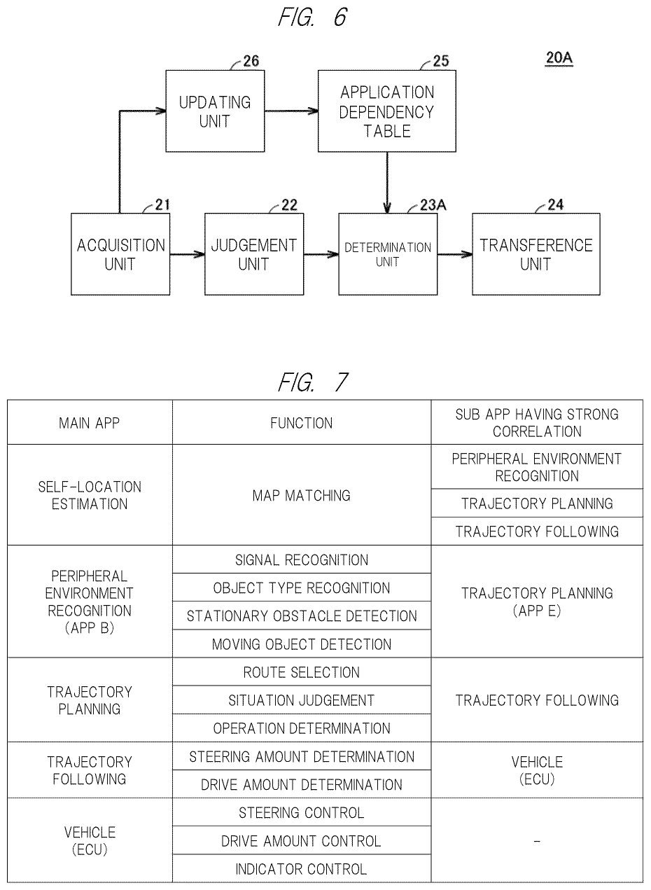

FIG. 6 is a view showing a configuration of a first example of a dynamical deployment process unit according to an embodiment. A dynamic deployment process unit 20A shown by FIG. 6 is a first example of the dynamic deployment process unit 20 shown by FIG. 1. The dynamic deployment process unit 20A includes an acquisition unit 21, the judgement unit 22, a determination unit 23A, the transference unit 24, an application dependency table 25, and the updating unit 26. The determination unit 23A is one example of the determination unit 23 shown by FIG. 1.

The acquisition unit 21 acquires data indicating the usage amount of the computing resource 30 by each application deployed in each of the plurality of management units 10. The data indicating the usage amount of the computing resource 30 is acquired from an OS operating at each management unit 10. The data indicates the CPU load and the memory usage amount.

The judgement unit 22 judges the resource use rate at each of the plurality of management units 10 based on the data acquired by the acquisition unit 21.

The application dependency table 25 indicates a combination of the applications, which have a dependency relationship about the fluctuation of the usage amount of the computing resource 30, among the plurality of applications. The application dependency table 25 is one example of “second information” of the present disclosure.

FIG. 7 is a view showing one example of an application dependency table. In FIG. 7, the application dependency table 25 corresponding to the plurality of applications for a vehicle is shown. The application dependency table 25 indicates a combination of a main application and one or more sub applications in which the usage amount of the computing resource 30 increases with the increase in the usage amount of the computing resource by the main application. In an example shown by FIG. 7, the application dependency table 25 indicates the combination of “App B” (peripheral environment recognition app) that is the main application and “App E” (trajectory planning app) that is the sub application. This means to increase the usage amount of the computing resource 30 by the “App E” with the increase in the usage amount of the computing resource 30 by “App B”.

Returning to FIG. 6, according to the judgement that the resource use rate at a target management unit among the plurality of management units 10 exceeds the first standard, the determination unit 23A uses the application dependency table 25 to determine the redeployment destination of the first application deployed in the target management unit.

When two or more applications 40 are deployed in the target management unit, the determination unit 23A may select the first application according to a priority preset to each of the two or more applications 40.

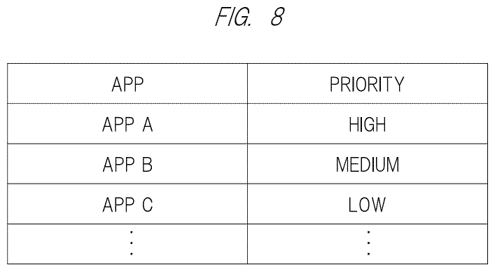

FIG. 8 is a view showing one example of a priority set to the application. The priority is preset according to a type of the application. As the priority is higher, importance of the application is higher. In an example shown by FIG. 8, as the priority, “high”, “medium”, and “low” are set. The priority of “App C” is set lower than the priority of “App A” and the priority of “App B”. As described above, the first application stops during a redeployment process. It is not preferable to stop the application having the high importance. Therefore, the determination unit 23A selects, as the first application, the application in which the priority is set at “low”.

After selecting the first application, the determination unit 23A determines the redeployment destination of the first application according to the following process.

That is, the determination unit 23A specifies the second application, which is a cause of the increase in the resource use rate, from among one or more applications 40 deployed in the target management unit. For example, the determination unit 23A calculates a first increase width of the usage amount of the computing resource 30 about each of the one or more applications 40 deployed in the target management unit. The first increase width is calculated based on a comparative result of the usage amounts of the computing resources 30 at the third timing judged that the resource use rate exceeds the first standard and at the fourth timing going back only in a preset time from the third timing. For example, the first increase width is an amount obtained by subtracting the usage amount at the fourth timing from the usage amount at the third timing. Or, the first increase width may be a value obtained by dividing the usage amount at the third timing by the usage amount at the fourth timing. The determination unit 23A specifies, as the second application, the application having the largest first increase width.

The determination unit 23A accesses the application dependency table 25. The determination unit 23A specifies, as the first information, one or more relative applications having the dependency relationship with the second application based on the application dependency table 25. Specifically, the determination unit 23A specifies, as one or more relative applications, one or more sub applications corresponding to the second application.

In the management unit 10 in which the relative application is deployed, the increase in the usage amount of the computing resource 30 is expected due to the relative application. In other words, in the management unit at which all of one or more relative applications are not deployed, the increase in the usage amount of the computing resource 30 is not expected. Therefore, the determination unit 23A determines, as the redeployment destination, the management unit, in which all of one or more relative applications are not deployed, from among the plurality of management units 10. Specifically, the determination unit 23A specifies one or more management units, which are lower in use rate than the second standard, from among the plurality of management units 10. Namely, the determination unit 23A specifies, as one or more redeployment destination candidates, one or more management units at which the resource use rate is “low”. The determination unit 23A determines, as the redeployment destination, the management unit, in which all of one or more relative applications are not deployed, from among one or more redeployment destination candidates.

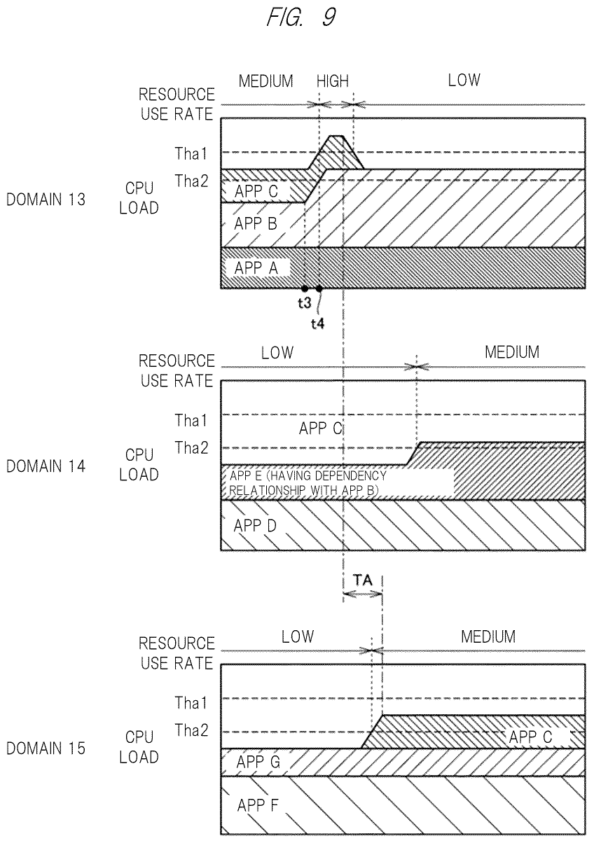

With reference to FIG. 7 to FIG. 9, a process example of the determination unit 23A will be explained. FIG. 9 is a view showing a temporal change of a CPU load in the plurality of management units relative to the first example. In FIG. 9, a temporal change of the CPU load in the domains 13, 14, 15 (see FIG. 2) included in the plurality of management units 10 is shown.

As shown in FIG. 9, from the timing t3, the CPU load by “App B” deployed in the domain 13 rises. As a result, at the timing t4 after the timing t3, the resource use rate of the domain 13 is judged as “high”.

According as the resource use rate in the domain 13 is judged as “high”, the determination unit 23A selects, as the first application to be the target of the redeployment, one application deployed in the domain 13. Specifically, according to the priority shown by FIG. 8, the determination unit 23A selects, as the first application, “App C”, in which the priority is set at “low”, among three applications deployed in the domain 13.

Next, the determination unit 23A calculates the first increase width of the usage amount of the computing resource 30 about each of “App A”, “App B”, and “App C” deployed in the domain 13. Namely, the determination unit 23A compares the usage amounts of the computing resources 30 at the third timing (timing t4) at which the resource use rate is judged as “high” and at the timing t4 going back only in the preset time from the timing t3, and calculates the first increase width. The determination unit 23A specifies, as the second application, “App B”having the largest first increase width.

Next, the determination unit 23A accesses the application dependency table 25 shown by FIG. 7. The determination unit 23A specifies, as the relative application, “App E” having the dependency relationship with the second application “App B” based on the application dependency table 25.

Next, the determination unit 23A specifies, as the redeployment destination candidate of the first application “App C”, the domains 14, 15 in which the resource use rate is “low”.

Next, the determination unit 23A determinates, as the redeployment destination, the domain 15, in which the relative application “App E” is not deployed, from among the domains 14, 15.

Consequently, after the redeployment process of “App C” is executed in the period TA, “App C” can continuously operate in the domain 15 that is the redeployment destination. That is, in comparison with the reference form explained with reference to FIG. 5, the number of times of the redeployment process of “App C” can be reduced. As a result, a time (stop time) when “App C” does not function substantially (stop time) becomes short.

Returning to FIG. 6, the updating unit 26 updates the application dependency table 25 based on a progress of the usage amount of the computing resource by each of the plurality of applications. According to version up of apparatuses, equipment, or the like to which the system 1 is applied, a new application(s) in the plurality of management units 10 can be deployed. Further, the application already deployed in any of the plurality of management units 10 can be updated. With addition of the new application or updating of the existing application, the dependency relationship between the applications can be changed. Therefore, the updating unit 26 updates the application dependency table 25 appropriately.

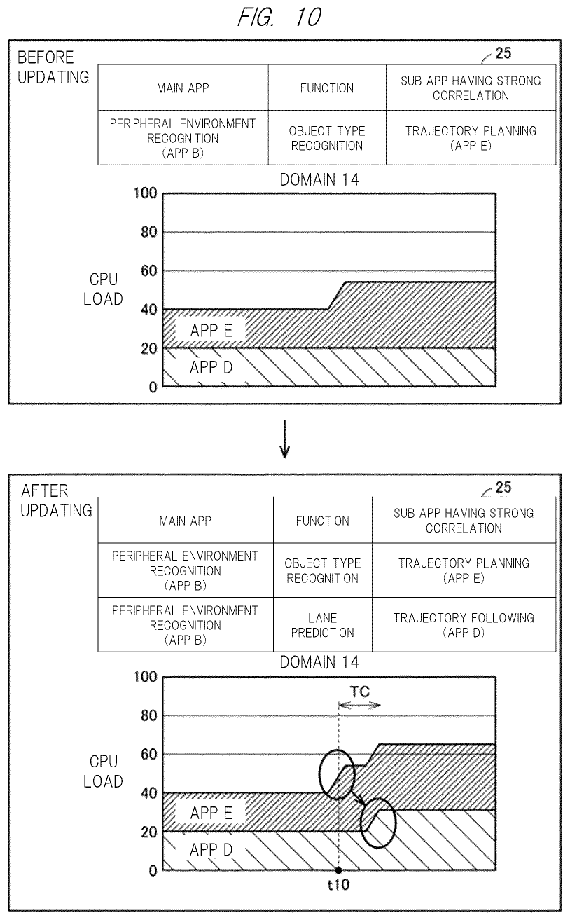

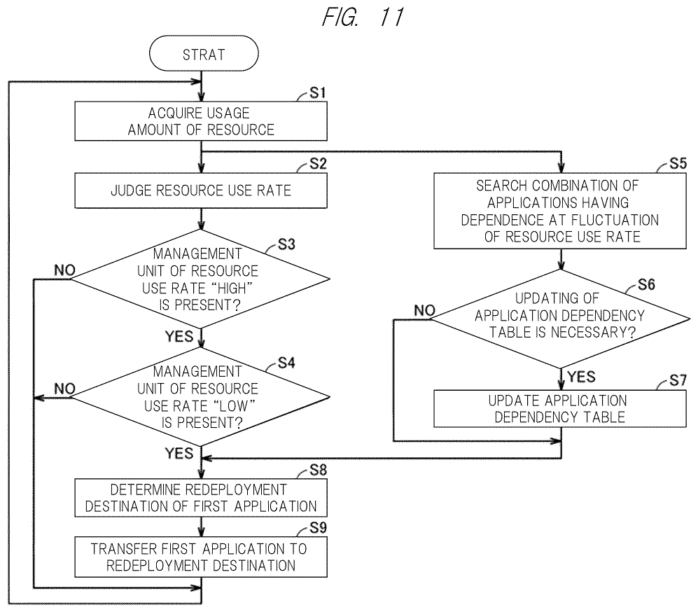

FIG. 10 is a diagram for explaining a process example by an updating unit. The updating unit 26 specifies, as a main application candidate, the application in which a second increase width of the usage amount of the computing resource 30 exceeds a threshold. The second increase width is calculated based on a comparison result of the usage amounts of the computing resources 30 at current timing and at fifth timing going back in a time preset from the current timing. For example, the second increase width is an amount obtained by subtracting the usage amount at the fifth timing 5 from the usage amount at the current timing. Or, the second increase width may be a value obtained by dividing the usage amount at the current timing by the usage amount at the fifth timing. Further, the updating unit 26 specifies, about the main application candidate, timing at which the second increase width exceeds the threshold (hereinafter, called “usage amount increase timing”). For example, in a process example shown by FIG. 10, at timing t10, the second increase width of the usage amount of the computing resource by “App E” exceeds the threshold. Therefore, the updating unit 26 specifies “App E” and the timing t10 as the main application candidate and the usage amount increase timing, respectively.

The updating unit 26 specifies, as a sub application candidate, the application in which a third increase width of the usage amount of the computing resource 30 in a first search period TC beginning from the usage amount increase timing exceeds the threshold. A time length of the first search period TC is preset. The third increase width is calculated based on a comparison result with the usage amounts of the computing resources 30 at sixth timing included in the first search period TC and at seventh timing going back in a time preset from the sixth timing. For example, the third increase width is an amount obtained by subtracting the usage amount at the seventh timing from the usage amount at the sixth timing. Or, the third increase width may be a value obtained by dividing the usage amount at the sixth timing by the usage amount at the seventh timing.

In the process example shown by FIG. 10, in the first search period TC beginning from the timing t10, the third increase width of the usage amount of the computing resource 30 by “App D” exceeds the threshold. Therefore, the updating unit 26 specifies “App D”as the sub application candidate.

The updating unit 26 determines, as a combination which should be added to the application dependency table 25, a combination candidate with the main application candidate and the sub application candidate. Or, the updating unit 26 determines, as the combination which should be added to the application dependency table 25, the combination candidate satisfying a preset addition condition. The updating unit 26 updates the application dependency table 25 according to a determined content. For example, in the process example shown by FIG. 10, the updating unit 26 adds, to the application dependency table 25, a combination including the main application “App E” and the sub application “App D”.

The addition condition is, for example, a condition in which a percentage of the number of times of the first search period TC exceeds a standard value, the first search period TC in which the third increase width of the usage amount of the computing resource 30 by the sub application candidate exceeds the threshold being one out of a plurality of first search periods TC corresponding to the main application candidate. The standard value is selected from, for example, between 50 percents and 90 percents.

Further, the updating unit 26 may delete a combination satisfying a deletion condition from the application dependency table 25. The deletion condition is, for example, a condition in which a percent of the number of times of a second search period is less than the standard value, the second search period in which a fourth increase width of the usage amount of the computing resource 30 by the sub application exceeds the threshold being one out of a plurality of second search periods corresponding to the main application. The second search period is a period beginning from timing at which an increase width of the usage amount of the computing resource 30 by the main application exceeds the threshold. A time length of the second search period is preset. The fourth increase width is calculated based on the comparison result of the usage amounts of the computing resources 30 at eighth timing included in the second search period and at ninth timing going back only in a time preset from the eighth timing. For example, the fourth increase width is an amount obtained by subtracting the usage amount at the ninth timing from the usage amount at the eighth timing. Or, the fourth increase width may be a value obtained by dividing the usage amount at the eighth timing by the usage amount at the ninth timing.

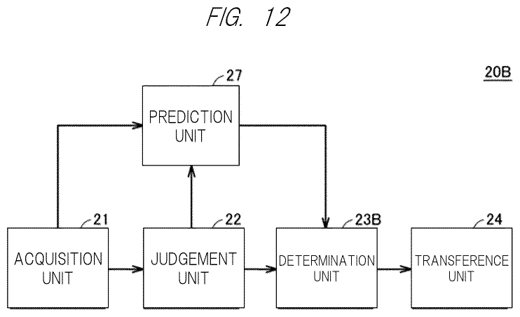

FIG. 11 is a flowchart showing one example of a flow of a process of a dynamic deployment unit relative to the first example. The processor operating as the acquisition unit 21 (for example, CPU 32) acquires the usage amount of the computing resource 30 by each application deployed in each of the plurality of management units 10 (Step S1).

Next, the processor operating as the judgement unit 22 judges the resource use rate about each of the plurality of management units 10 (Step S2).

Next, the processor operating as the determination unit 23A determines whether a target management unit in which the resource use rate is higher than the first standard, namely, the target management unit in which the resource use rate is “high” is present or not (Step S3). When the target management unit is present (YES in Step S3), the processor determines whether one or more management units at which the resource use rate is lower than the second standard, namely, one or more management units in which the resource use rate is lower than the second standard (deployment destination candidate) is present or not (Step S4).

When one or more deployment destination candidates is present (YES in Step S4), the processor selects, as the first application, one application deployed in the target management unit. Then, the processor determines the redeployment destination of the first application from among the one or more deployment destination candidates based on the application dependency table 25 (Step S8).

Next, the processor operating as the transference unit 24 transfers the first application to the redeployment destination from the target management unit (Step S9). After Step S9, the process returns to Step S1. When the target management unit is not present (NO in Step S3), the processor determines that the redeployment process is unnecessary, and returns the process to Step S1. In addition, when the one or more deployment destination candidates are not present (NO in Step S4), the processor determines that the redeployment process is impossible, and returns the process to Step S1.

In parallel to Step S2 to Step S4, Step S5 to Step S7 are carried out. In Step S5, the processor operating as the updating unit 26 analyzes the progress of the usage amount of the computing resource 30 by each application, and searches a combination of the applications having the dependency relationship about the fluctuation of the usage amount of the computing resource.

In Step S6, the processor judges whether the updating of the application dependency table 25 is necessary or not. For example, the processor judges whether a combination candidate satisfying the addition condition is present or not and whether a combination satisfying the deletion condition is present or not. The processor judges that the updating of the application dependency table 25 is necessary according as the combination candidate satisfying the addition condition or the combination satisfying the deletion condition is present.

When the updating of the application dependency table 25 is necessary (YES in Step S6), the processor updates the application dependency table 25 at Step S7. When the updating of the application dependency table 25 is unnecessary (NO in Step S6), Step S7 is omitted.

### SECOND EXAMPLE

FIG. 12 is a view showing a configuration of a second example of the dynamic deployment unit relative to the first example. A dynamic deployment process unit 20B shown by FIG. 12 is a second example of the dynamic deployment process unit 20 shown by FIG. 1. The dynamic deployment process unit 20B is different from the dynamic deployment process unit 20A shown by FIG. 6 in that it includes a determination unit 23B and a prediction unit 27 instead of the application dependency table 25 and the updating unit 26. The determination unit 23B is one example of the determination unit 23 shown by FIG. 1.

The prediction unit 27 predicts the future usage amount of the computing resource 30 in each of the plurality of management units 10 based on the usage amount at the current timing of the computing resource 30 in each of the plurality of management units. For example, the prediction unit 27 predicts the usage amount of the computing resource 30 at timing passing only a time preset from the current timing. The usage amount at present of the computing resource 30 in each of the plurality of management units is calculated based on the data acquired by the acquisition unit 21.

The prediction unit 74 uses the known technique and a technique applying the known technique to predict the future usage amount of the computing resource 30. The known technique includes, for example, a pattern matching, an Autoregressive Moving Average (ARMA) model, an Autoregressive Integrated Moving Average (ARIMA) model, a Seasonal Autoregressive Integrated Moving Average (SARIMA) mode, and a Prophet model.

The prediction unit 27 may predict the future usage amount of the computing resource 30 only about the management unit in which the resource use rate is judged as “low” by the judgement unit 22 (namely, redeployment destination candidate).

The application in which the priority “high” or the priority “medium” is set is not selected as the target of the redeployment. One or more applications deployed in each management unit usually includes the application in which the priority “high” or the priority “medium” is set. Therefore, the progress of the usage amount of the computing resource 30 in each of the plurality of management units can be modeled based on the operation of the application in which the priority “high” or the priority “medium” is set. Consequently, the prediction unit 27 can predict the future usage amount of the computing resource 30 in each of the plurality of management units 10 with high accuracy.

The determination unit 23B acquires, as the first information, a prediction result by the prediction unit 27. Then, the determination unit 23B determines, as the redeployment destination of the first application, the management unit, which is expected so that the usage amount does not increase, among the plurality of management units 10 based on the prediction result.

Specifically, the determination unit 23B specifies one or more management units, in which the resource use rate is lower than the second standard, among the plurality of management units 10. Namely, the determination unit 23B specifies, as one or more redeployment destination candidates, one or more management units in which the resource use rate is “low”. The determination unit 23A determines, as the redeployment destination, the redeployment destination candidate, which is predicted so that the further usage amount does not increase, in one or more redeployment destination candidates.

Note that the prediction unit 27 may predict the future usage amount of the computing resource 30 in each application based on the usage amount at the current timing of the computing resource 30 in each application deployed in the plurality of management units 10. Then, the prediction unit 27 may predict the future usage amount of the computing resource 30 in each of the plurality of management units 10 based on the future usage amount of the computing resource 30 in each application.

### Modification Example

The plurality of management units 10 may include only the plurality of domains provided to one device. At this case, the system 1 is configured by the above device.

The determination unit 23 may select, as the first application, the application set at the priority “medium” when the application set at the priority “low” is not present in the target management unit.

As described above, the invention made of the present inventor has been specifically explained based on the embodiments, but the present invention is not limited to the above embodiments and, needless to say, can be variously modified within a range not departing from the gist thereof.

What is claimed is:

1. A device dynamically deploying an application in any of a plurality of management units, a computing resource being allocated to the plurality of management units, the device comprising:
a judgement unit judging a use rate of the computing resource in each of the plurality of management units; and
a determination unit determining a redeployment destination of a first application in a target management unit, which is higher in the use rate than a first standard, among the plurality of management units,
wherein based on first information about a future fluctuation of a usage amount of the computing resource in the plurality of management units, the determination unit determines a management unit, which is expected so that the usage amount does not increase, from among the plurality of management units as the redeployment destination.

2. The device according to claim 1,
wherein the determination unit:
specifies a second application, which is a cause of an increase in the use rate, from among one or more applications deployed in the target management unit;
accesses second information indicating a combination of applications, which has a dependency relationship about the fluctuation of the usage amount of the computing resource, among a plurality of applications deployed in the plurality of management units;
specifies, as the first information, one or more relative applications having the dependency relationship with the second application based on the second information; and
determines, as the redeployment destination, a management unit, which is not deployed in any of the one or more relative applications, among the plurality of management units.

3. The device according to claim 2,
wherein the second information indicates a combination of a main application and one or more sub applications in which the usage amount of the computing resource increases with an increase in the usage amount of the computing resource by the main application, and
wherein the one or more relative applications is the one or more sub applications corresponding to the second application.

4. The device according to claim 2, further comprising:
an acquisition unit acquiring the usage amount of the computing resource by each of the plurality of applications; and
an updating unit updating the second information based on a progress of the usage amount corresponding to each of the plurality of applications.

5. The device according to claim 1, further comprising a prediction unit predicting a future usage amount of the computing resource in each of the plurality of management units based on a current usage amount of the computing resource in each of the plurality of management units,
wherein the determination unit acquires, as the first information, a prediction result by the prediction unit.

6. The device according to claim 1,
wherein the determination unit specifies one or more management units lower in the use rate than a second standard from among the plurality of management units, the second information being less than a threshold from the first standard, and
wherein the determination unit determines the redeployment destination from among the one or more management units.

7. The device according to claim 1,
wherein the first application is selected from among two or more applications deployed in the target management unit according to a priority preset to each of the two or more applications.

8. The device according to claim 1, further comprising a transference unit transferring the first application to the redeployment destination from the target management unit.

9. The device according to claim 1,
wherein the plurality of management units include a plurality of domains provided to the device.

10. The device according to claim 9,
wherein the plurality of management units further include any of another device different from the device and a plurality of domains provided to the another device.

11. A system comprising:
a plurality of management units, a computing resource being allocated to the plurality of management units;
a judgement unit judging a use rate of the computing resource in each of the plurality of management units;
a determination unit determining, according as the use rate in a target management unit among the plurality of management units exceeds a first threshold, a redeployment destination of a first application deployed in the target management unit; and
a transference unit transferring the first application to the redeployment destination from the target management unit,
wherein the determination unit determines, based on first information about a future fluctuation of a usage amount of the computing resource in the plurality of management units, a management unit, which is expected so that the usage amount does not increase, from among the plurality of management units as the deployment destination.

12. A method for dynamically deploying an application in any of a plurality of management units to which a computing resource is allocated, the method comprising:
judging a use rate of the computing resource in each of the plurality of management units; and
determining, according as the use rate in a target management unit among the plurality of management units exceeds a first threshold, a redeployment destination of a first application deployed in the target management unit,
wherein determining the redeployment destination includes determining, based on first information about a future fluctuation of a usage amount of the computing resource in the plurality of management units, a management unit, which is expected so that the usage amount does not increase, from among the plurality of management units as the redeployment destination.
